(19) United States
(12) Patent Application Publication
(10) Pub. No.: US 2018/0056242 A1
(43) Pub. Date: Mar. 1, 2018

(54) COMBINED ELECTRODIALYSIS AND PRESSURE MEMBRANE SYSTEMS AND METHODS FOR PROCESSING WATER SAMPLES

(71) Applicant: Board of Regents, The University of Texas System, Austin, TX (US)

(72) Inventors: Lynn E. Katz, Austin, TX (US); Desmond F. Lawler, Austin, TX (US); Soyoon Kum, Austin, TX (US)

(21) Appl. No.: 15/690,843

(22) Filed: Aug. 30, 2017

Related U.S. Application Data
(60) Provisional application No. 62/381,312, filed on Aug. 30, 2016.

(51) Int. Cl. B01D 61/58; C02F 1/469; C02F 1/44; C02F 9/00

(52) U.S. Cl. CPC B01D 61/58; C02F 1/4693; C02F 1/441; C02F 2103/007; C02F 9/00; C02F 2301/08; C02F 1/442

(57) ABSTRACT

The present invention provides combined electrodialysis and pressure membrane systems and methods for processing and treating water samples. These improved systems and methods use electrodialysis in combination with a pressure membrane process to remove organic matter from water sources while retaining ion concentrations appropriate for drinking water.

### CROSS REFERENCE TO RELATED APPLICATIONS

This application claims the benefit of U.S. Provisional Patent Application Ser. No. 62/381,312 filed Aug. 30, 2016, the disclosure of which is expressly incorporated herein by reference.

### STATEMENT REGARDING FEDERALLY SPONSORED RESEARCH

This invention was made with government support under Grant No. 83560201 awarded by the Environmental Protection Agency. The Government has certain rights in the invention.

### FIELD

The present invention relates to systems and methods for processing and treating water samples.

### BACKGROUND

Natural organic matter (NOM) is ubiquitous in surface waters (lakes, rivers) and can also occur in groundwater. NOM is problematic in water treatment because it reacts with chemicals added as disinfectants to form “disinfection by-products” (DBPs), many of which are known or suspected carcinogens. NOM removal is dictated by Environmental Protection Agency (EPA) regulations in the “Disinfection/Disinfection By-Product (D/DBP) Rule”. Current approaches to dealing with DBPs involve removing DBPs after they are formed, using alternative disinfectants to reduce DBP formation, and/or removing the NOM from the water before or simultaneously with disinfection. For some utilities, none of these approaches is entirely satisfactory, and the problem of balancing disinfection needs of drinking water and DBP production has been the central problem facing water utilities for more than three decades.

There are several methods that have been used for removing organic matter (for example, natural organic matter) from water samples. Coagulation/flocculation and membrane processes—such as Ultra Filtration (UF), Nano Filtration (NF), and reverse osmosis (RO)—are possible methods to remove NOM. Among the available treatment methods, RO is superior in terms of NOM rejection in the feed water. RO has been shown to be effective in removing NOM from fresh water. However, the presence of Ca²⁺ increases fouling due to the bridging of organic molecules. High concentrations of Ca²⁺ also lead to precipitate formation, usually calcium carbonate (CaCO₃).

Another common technology for removing NOM from drinking water supplies is “enhanced coagulation.” In this process, metal salts (typically iron or aluminum based) are added to the water to precipitate the metal hydroxide and allow NOM to adsorb onto the newly formed solids. Traditionally (i.e., prior to the understanding of the effects of NOM), metal coagulation was used similarly to remove particles from the water; the term “enhanced coagulation” refers to the use of this process to remove NOM in addition to particles. Enhanced coagulation works to different extents depending on the alkalinity of the water, the concentration of the dissolved organic carbon (DOC/NOM), and the nature of the NOM (which varies from water source to water source); it is rare for enhanced coagulation to achieve more than 40% removal of DOC, and for many waters, removing even 15% of the DOC by this technique is difficult or impossible.

Another process that can remove DOC from water is adsorption onto activated carbon. This process is rarely used because it is quite expensive and presents a variety of operating problems. What is needed are improved systems and methods for processing and treating water samples for the removal of organic matter.

The systems and methods disclosed herein address these and other needs.

### SUMMARY

The present disclosure provides combined electrodialysis and pressure membrane systems and methods for processing and treating water samples. These improved systems and methods use electrodialysis in combination with a pressure membrane process to remove organic matter from water sources while retaining ion concentrations appropriate for drinking water.

In one aspect, provided herein is a system for processing a water sample, comprising:
a) an electrodialysis unit; and
b) a pressure membrane unit;
   wherein the pressure membrane unit is present in the system after the electrodialysis unit, and wherein the system removes organic matter present in the water sample, and the system retains a significant percentage of cations and anions in the water sample.

In one embodiment, the water sample is a surface water source. In one embodiment, the water sample comprises wastewater.

In one embodiment, the pressure membrane unit comprises a membrane suitable for nanofiltration. In one embodiment, the pressure membrane unit comprises a membrane suitable for reverse osmosis.

In one embodiment, the electrodialysis unit comprises a cation selective membrane and an anion selective membrane. In one embodiment, the electrodialysis unit comprises an electrodialysis stack, wherein the electrodialysis stack is comprised of at least two (for example, at least two, at least three, at least four, at least five, etc.) alternating cation selective membranes and anion selective membranes in series. In one embodiment, the system contains at least two electrodialysis units. In one embodiment, the system contains at least two pressure membrane units.

In one embodiment, the system further comprises a diluate stream from the electrodialysis unit which is further processed by the pressure membrane unit. In one embodiment, the diluate stream from the electrodialysis unit that is processed by the pressure membrane unit, is combined with the concentrate from the electrodialysis unit.

In another aspect, provided herein is method for the removal of organic matter from a water sample, comprising:
a) providing a water sample;
b) separating the water sample by electrodialysis into a first concentrate stream and a first diluate stream, wherein the first concentrate stream comprises a higher fraction of ions than the water sample and the first diluate stream comprises a lower fraction of ions than the water sample;
c) processing the first diluate stream in a pressure membrane process into a second concentrate stream and a second diluate stream, wherein the second concentrate stream comprises a higher fraction of organic matter than the water sample and the second diluate stream comprises a lower fraction of organic matter than the water sample; and
d) combining the second diluate stream with the first concentrate stream.

In one embodiment, the water sample is a surface water source or groundwater under the influence of surface water.

In one embodiment, the pressure membrane process is nanofiltration. In one embodiment, the pressure membrane process is reverse osmosis.

In one embodiment, the electrodialysis comprises a cation selective membrane and an anion selective membrane. In one embodiment, the electrodialysis comprises an electrodialysis stack, wherein the electrodialysis stack is comprised of at least two (for example, at least two, at least three, at least four, at least five, at least six, at least seven, at least eight, at least nine, at least ten, etc.) alternating cation selective membranes and anion selective membranes in series. In one embodiment, the method uses at least two electrodialysis units. In one embodiment, the method uses at least two pressure membrane units.

In one embodiment, the pressure membrane process comprises a membrane suitable for nanofiltration. In one embodiment, the pressure membrane process comprises a membrane suitable for reverse osmosis.

In one embodiment, the method further comprises a first diluate stream that is further separated by an additional round of electrodialysis before processing in a pressure membrane process.

### BRIEF DESCRIPTION OF THE DRAWINGS

The accompanying figures, which are incorporated in and constitute a part of this specification, illustrate several aspects described below.

FIG. 1 shows a schematic diagram of a coupled electrodialysis (ED)-reverse osmosis (RO) system.

FIG. 2 shows a schematic of a batch-recycle experimental electrodialysis (ED) apparatus.

FIG. 3 shows a schematic diagram of series electrodialysis (ED).

FIG. 4 is a graph showing the conductivity change with time in cation selective membrane (CMV) and anion selective membrane (AMV) membrane pairs without natural organic matter (NOM). Note that some data are missing due to conductivity meter buffering, which occurs when a receiving unit has an operating speed lower than that of the unit feeding data to it.

FIG. 5 is a graph showing the conductivity change with time in PCSK/PCSA membrane pairs without natural organic matter (NOM). Note that some data are missing due to conductivity meter buffering, which occurs when a receiving unit has an operating speed lower than that of the unit feeding data to it.

FIG. 6 is a graph showing the conductivity change with time in cation selective membrane (CMV) and anion selective membrane (AMV) membrane pairs, with natural organic matter (NOM).

FIG. 7 is a graph showing the conductivity change with time in PCSK/PCSA membrane pairs with natural organic matter (NOM).

FIG. 8 is a graph showing natural organic matter (NOM) UV absorbance change with time in CMV/AMV and PCSK/PCSA membrane pairs from the first series.

FIG. 9 is a graph showing natural organic matter (NOM) UV absorbance change with time in CMV/AMV and PCSK/PCSA membrane pairs from the second series.

FIG. 10 is a graph showing ion (sodium, calcium, and magnesium) concentration change and UV absorbance change with specific energy in PCSK/PCSA membrane pairs with Suwannee River natural organic matter (NOM).

FIG. 11 is a graph showing ion (sodium, calcium, and magnesium) concentration change and UV absorbance change with specific energy in CMX/AMX membrane pairs with Suwannee River natural organic matter (NOM).

FIG. 12 is a graph showing ion (sodium, calcium, and magnesium) concentration change and UV absorbance change with specific energy in CMX/AMX membrane pairs with Leonardite Humic Acid.

FIG. 13 is a graph showing ion rejection and Suwannee River NOM rejection in nanofiltration experiments.

### DETAILED DESCRIPTION

The present disclosure provides combined electrodialysis and pressure membrane systems and methods for processing and treating water samples. These improved systems and methods use electrodialysis in combination with a pressure membrane process to remove organic matter from water sources while retaining ion concentrations appropriate for drinking water.

Reference will now be made in detail to the embodiments of the invention, examples of which are illustrated in the drawings and the examples. This invention may, however, be embodied in many different forms and should not be construed as limited to the embodiments set forth herein.

Unless defined otherwise, all technical and scientific terms used herein have the same meaning as commonly understood to one of ordinary skill in the art to which this invention belongs.

### Systems and Methods for Treating and Processing Water Samples

Since the discovery that disinfectants, particularly chlorine, react with NOM in water to form halogenated organic compounds that are known or thought to be carcinogenic, water utilities have struggled to balance the need for disinfection (so that customers' immediate health is protected) and the need to limit the formation of disinfection by-products (DBPs). The approaches to dealing with this problem have involved removing DBPs after they are formed, using alternative disinfectants to reduce the formation of DBPs (but sometimes just changing the nature of the DBPs formed), and/or removing the NOM from the water before or simultaneously with the disinfection. For some utilities, none of these approaches is entirely satisfactory, and it is fair to say that this problem of balancing the disinfection and disinfection by-products has been the central problem facing water utilities for more than three decades. The present invention can allow many utilities to eliminate the worry about DBPs and allow full disinfection.

Disclosed herein is a unique combination of water treatment technologies and is designed to remove organic matter, for example natural organic matter (NOM), from water sources. These water sources include surface water sources, or drinking water, and can also include wastewater or reuse water. NOM is ubiquitous in surface waters (lakes, rivers) and often occurs in groundwater as well. NOM is problematic in water treatment because it reacts with chemicals added as disinfectants to form “disinfection by-products” (DBPs). NOM removal is dictated by USEPA regulations in the “Disinfection/Disinfection By-Product (D/DBP) Rule; NOM is measured in terms of dissolved organic carbon (DOC) and the D/DBP Rule mandates specific levels of removal that depend on the raw water DOC concentration and the raw water alkalinity.

In one embodiment, the method involves a combination of two membrane processes: electrodialysis and a pressure membrane process, for example, either nanofiltration or reverse osmosis. These two processes are used in tandem in a unique way that removes NOM while preserving nearly the same concentrations of minerals and ions that are desirable in drinking water. Both of these processes have been used in the field for desalination, but with this combination, the ion concentration is reduced only to a small amount while the NOM concentration is reduced substantially.

In some embodiments, in the electrodialysis step, a single influent stream of water is divided (approximately equally in terms of volume or flow rate) into a “concentrate” stream which contains a high fraction of the ions present in the original water and a “diluate” stream, which contains a much lower concentration of the original ions. Electrodialysis (ED) is very efficient in transporting inorganic ions into these two streams, but NOM, although it is generally negatively charged in drinking water sources, is not removed well. With multiple passes through an ED system (or with multiple systems in series in which the latter stages are fed the concentrate of the previous stage), the diluate can contain a high fraction of the original volume, a similarly high fraction of the mass of NOM, and a low concentration of inorganic ions. Also, the concentrate is a small fraction of the volume, a similar fraction of the NOM, and a high concentration of the inorganic ions (salts).

The diluate is then fed to a pressure membrane process, for example, either a nanofiltration (NF) membrane or a reverse osmosis (RO) membrane. These processes are similar except for the “tightness” of the membrane and the pressure involved in passing water through the membrane. Either of these processes is highly efficient at removing the NOM molecules (as they are relatively large) but is less efficient (especially NF membranes) in removing ions. These processes also separate the water into “concentrate” and “diluate” streams. In this case, the NOM is largely prevented from passing through the membrane and virtually all will be in the concentrate stream; the ions are removed to a lesser extent (especially if NF is used rather than RO) and the diluate stream contains a high fraction of the water fed to the RO or NF membrane, a substantial fraction of the ions (depending on the membrane used), and very little of the NOM. Finally, the concentrate stream from the ED system(s) and the diluate stream from the RO/NF process are combined; this water has a high fraction of the original volume of water, a similar high fraction (significant percentage) of the original inorganic ions and salts, but a greatly reduced mass (or concentration) of the original NOM.

In previous water treatment processes, the product is the diluate and the concentrate is considered a waste stream. In the present invention, both streams of the ED are utilized, but the separation of the salts in the ED prior to the RO/NF system allows the second system to isolate the removal of NOM, and the subsequent mixing of the ED concentrate and the RO/NF diluate will create a drinking water source that can be disinfected without worry about creating excessive DBPs. The removal of NOM can exceed the removals achieved in current conventional technologies, with the most common being “enhanced coagulation” in which NOM is adsorbed onto solids precipitated in the water, such as aluminum hydroxide or ferric hydroxide.

In one aspect, provided herein is a system for processing a water sample, comprising:
a) an electrodialysis unit; and
b) a pressure membrane unit;
   wherein the pressure membrane unit is present in the system after the electrodialysis unit, and wherein the system removes organic matter present in the water sample, and the system retains a significant percentage of cations and anions in the water sample.

In one aspect, provided herein is a system for processing a water sample, consisting essentially of:
a) an electrodialysis unit; and
b) a pressure membrane unit;
   wherein the pressure membrane unit is present in the system after the electrodialysis unit, and wherein the system removes organic matter present in the water sample, and the system retains a significant percentage of cations and anions in the water sample.

In one aspect, provided herein is a system for processing a water sample, consisting of:
a) an electrodialysis unit; and
b) a pressure membrane unit;
   wherein the pressure membrane unit is present in the system after the electrodialysis unit, and wherein the system removes organic matter present in the water sample, and the system retains a significant percentage of cations and anions in the water sample.

In one embodiment, the water sample is a surface water source.

In one aspect, provided herein is a system for processing a water sample, comprising:
a) an electrodialysis unit; and
b) a pressure membrane unit;
   wherein the pressure membrane unit is present in the system after the electrodialysis unit, and wherein the system removes natural organic matter present in the water sample, and the system retains a significant percentage of cations and anions in the water sample.

In one aspect, provided herein is a system for processing a water sample, consisting essentially of:
a) an electrodialysis unit; and
b) a pressure membrane unit;
   wherein the pressure membrane unit is present in the system after the electrodialysis unit, and wherein the system removes natural organic matter present in the water sample, and the system retains a significant percentage of cations and anions in the water sample.

In one aspect, provided herein is a system for processing a water sample, consisting of:
a) an electrodialysis unit; and
b) a pressure membrane unit;
   wherein the pressure membrane unit is present in the system after the electrodialysis unit, and wherein the system removes natural organic matter present in the water sample, and the system retains a significant percentage of cations and anions in the water sample.

In one embodiment, the water sample is a surface water source.

In one embodiment, the pressure membrane unit comprises a membrane suitable for nanofiltration. In one embodiment, the pressure membrane unit comprises a membrane suitable for reverse osmosis.

In one embodiment, the electrodialysis unit comprises a cation selective membrane and an anion selective membrane. In one embodiment, the electrodialysis unit comprises an electrodialysis stack, wherein the electrodialysis stack is comprised of at least two (for example, at least two, at least three, at least four, at least five, etc.) alternating cation selective membranes and anion selective membranes in series. In one embodiment, the system contains at least two electrodialysis units. In one embodiment, the system contains at least two pressure membrane units.

In one embodiment, the system further comprises a diluate stream from the electrodialysis unit which is further processed by the pressure membrane unit. In one embodiment, the diluate stream from the electrodialysis unit that is processed by the pressure membrane unit, is combined with the concentrate from the electrodialysis unit.

In another aspect, provided herein is method for the removal of organic matter from a water sample, comprising:
a) providing a water sample;
b) separating the water sample by electrodialysis into a first concentrate stream and a first diluate stream, wherein the first concentrate stream comprises a higher fraction of ions than the water sample and the first diluate stream comprises a lower fraction of ions than the water sample;
c) processing the first diluate stream in a pressure membrane process into a second concentrate stream and a second diluate stream, wherein the second concentrate stream comprises a higher fraction of organic matter than the water sample and the second diluate stream comprises a lower fraction of organic matter than the water sample; and
d) combining the second diluate stream with the first concentrate stream.

In another aspect, provided herein is method for the removal of natural organic matter from a water sample, comprising:
a) providing a water sample;
b) separating the water sample by electrodialysis into a first concentrate stream and a first diluate stream, wherein the first concentrate stream comprises a higher fraction of ions than the water sample and the first diluate stream comprises a lower fraction of ions than the water sample;
c) processing the first diluate stream in a pressure membrane process into a second concentrate stream and a second diluate stream, wherein the second concentrate stream comprises a higher fraction of natural organic matter than the water sample and the second diluate stream comprises a lower fraction of natural organic matter than the water sample; and
d) combining the second diluate stream with the first concentrate stream.

In one embodiment, the water sample is a surface water source. In one embodiment, the water sample comprises wastewater. In one embodiment, the pressure membrane process is nanofiltration. In one embodiment, the pressure membrane process is reverse osmosis.

In one embodiment, the electrodialysis comprises a cation selective membrane and an anion selective membrane. In one embodiment, the electrodialysis comprises an electrodialysis stack, wherein the electrodialysis stack is comprised of at least two (for example, at least two, at least three, at least four, at least five, at least six, at least seven, at least eight, at least nine, at least ten, etc.) alternating cation selective membranes and anion selective membranes in series. In one embodiment, the method uses at least two electrodialysis units. In one embodiment, the method uses at least two pressure membrane units.

In one embodiment, the pressure membrane process comprises a membrane suitable for nanofiltration. In one embodiment, the pressure membrane process comprises a membrane suitable for reverse osmosis.

In one embodiment, the method further comprises a first diluate stream that is further separated by an additional round of electrodialysis before processing in a pressure membrane process.

In one embodiment, the electrodialysis unit comprises a cation selective membrane. In one embodiment, the electrodialysis unit comprises an anion selective membrane. In one embodiment, the electrodialysis unit comprises a cation selective membrane and an anion selective membrane. In one embodiment, the electrodialysis unit comprises an electrodialysis stack, wherein the electrodialysis stack is comprised of at least two (for example, at least two, at least three, at least four, at least five, at least six, at least seven, at least eight, at least nine, at least ten, etc.) alternating cation selective membranes and anion selective membranes in series.

In one embodiment, the electrodialysis unit comprises a CMV/AMV membrane pair. In one embodiment, the electrodialysis unit comprises a PCSK/PCSA membrane pair. In one embodiment, the electrodialysis unit comprises a CMX/AMX membrane pair. In one embodiment, the pressure membrane process is reverse osmosis. In one embodiment, the pressure membrane process is nanofiltration. In some embodiments, any pressure membrane process that sufficiently removes the organic matter may be used in the methods of the invention.

In one embodiment, the method includes at least one (for example, at least one, at least two, at least three, at least four, at least five, etc.) round of electrodialysis treatment of the water sample. In one embodiment, the method includes at least one (for example, at least one, at least two, at least three, at least four, at least five, etc.) round of pressure membrane treatment of the water sample.

In some embodiments, the systems and methods disclosed herein can be further combined with an additional water treatment method (or additional method of removing natural organic matter), for example, coagulation, enhanced coagulation, flocculation, ultrafiltration, and/or adsorption onto activated carbon.

Coagulation/flocculation and membrane processes—such as Ultra Filtration (UF), Nano Filtration (NF), and reverse osmosis (RO)—are possible methods to remove NOM. Among the available treatment methods, RO is superior in terms of NOM rejection in the feed water. RO has been shown to be effective in removing NOM from fresh water (Shen, J., & Schäfer, A. I. (2015). Science of the Total Environment, 527-528, 520-529). However, the presence of Ca²⁺ increases fouling due to the bridging of organic molecules (Lee, S., and Elimelech, M., (2006). Environmental Science & Technology, 40, 980-987). High concentrations of Ca²⁺ also lead to precipitate formation, usually calcium carbonate (CaCO₃). Therefore, temporary removal of ions prior to RO can provide a cost-effective technology for select systems. Ions—such as Ca²⁺—in NOM-containing natural water can be removed by electrodialysis (ED).

The previous most common technology for removing NOM from drinking water supplies is “enhanced coagulation.” In this process, metal salts (typically iron or aluminum based) are added to the water to precipitate the metal hydroxide and allow NOM to adsorb onto the newly formed solids. Traditionally (i.e., prior to the understanding of the effects of NOM), metal coagulation was used similarly to remove particles from the water; the term “enhanced coagulation” refers to the use of this process to remove NOM in addition to particles. Enhanced coagulation works to different extents depending on the alkalinity of the water, the concentration of the DOC (NOM), and the nature of the NOM (which varies from water source to water source); it is rare for enhanced coagulation to achieve more than 40% removal of DOC, and for many waters, removing even 15% of the DOC by this technique is difficult or impossible. The present invention can achieve higher DOC removals and the removal efficiency is less dependent on the source water characteristics.

Another process that can remove DOC from water is adsorption onto activated carbon. This process is rarely used because it is quite expensive and presents a variety of operating problems. The present invention presents fewer operational problems and the operating costs can be lower than that of activated carbon adsorption.

The water sample to be used in the methods of the current invention include any water sample containing organic matter (for example, natural organic matter). These water samples include for example, surface water sources or groundwater. Additional water samples may also include a marine, estuarine, coastal, freshwater (such as a lake, well or reservoir), or a brackish water sample.

Surface water sources are those that occur on the surface of the planet. Non-limiting examples of surface water sources include, rivers, lakes, reservoirs, wetlands, and oceans. This is in contrast to groundwater sources (water beneath the Earth's surface) and atmospheric water sources.

In some embodiments, the water sample can include wastewater. Certain embodiments of the disclosure are directed to systems and methods of treating wastewater and wastewater effluent. Typically, the waste to be treated, such as wastewater, a wastewater feed, or a wastewater stream, contains waste matter which, in some cases, may comprise soluble organic material. Prior to discharge to the environment, such streams may require treatment to decontaminate or at least partially render the wastewater stream benign or at least satisfactory for discharge under established regulatory requirements or guidelines. As used herein, the terms “wastewater” or “wastewater stream” refer to water to be treated such as streams or bodies of water from residential, commercial, municipal, industrial, and agricultural sources, as well as mixtures thereof, that typically contain at least one undesirable species of organic matter. In some embodiments, the terms “wastewater” or “wastewater stream” include wastewater (domestic or industrial) effluent organic water, produced water, greywater, or light greywater.

The term “organic matter” as used herein refers to dissolved organic material or colloidal organic material. The dissolved organic material or colloidal organic material can be from surface or ground water, from wastewater treatment plants (domestic and industrial), water-soluble organic matter from compost or other biologically similar organic waste treated or stabilized under aerobic and/or anaerobic conditions. In some embodiments, the term “organic matter” encompasses high molecular weight organic matter (for example, greater than 100 Daltons).

“Natural Organic Matter” (NOM) refers to the organic matter/material present in surface or ground water. Organic matter (including NOM) causes color and taste problems and reacts with Cl₂ to form disinfection byproducts such as trihalomethanes (THMs) and haloacetic acids (HAAs) that can increase the risk of cancer. Because regulatory limits not only focus on select disinfection byproducts (DBPs) (e.g., THMs and a subset of five HAAs) but also require reduction of NOM in treatment plants with a surface water source and groundwater under the influence of surface water, it is often advantageous to focus on removal of DBP precursors prior to disinfection to minimize health risks. Indeed, removal of NOM prior to disinfection can indirectly reduce health risks associated with both regulated and other DBPs.

Due to their known and potential health effects, the EPA regulates the presence of disinfection byproducts (DBPs) in drinking water under the Stage 1 and Stage 2 Disinfection/Disinfection Byproducts Rules implemented in 2001 and 2006, respectively. The disinfection byproducts of note include, for example, the four trihalomethanes (THMs): trichloromethane (or chloroform), bromodichloromethane, dibromochloromethane, and tribromomethane (or bromoform). The EPA regulates trihalomethanes because prolonged consumption above the maximum contaminant level of 0.08 mg/L can cause various cancers. Small water systems, serving less than 10,000 consumers, are the mostly likely group to violate this regulation. As such, various technologies exist either to limit the production of DBPs through precursor removal or to remove these byproducts after formation. Some of these prior technologies include packed tower aeration, granular activated carbon adsorption, and hollow fiber membrane air stripping.

### EXAMPLES

The following examples are set forth below to illustrate the systems, methods and results according to the disclosed subject matter. These examples are not intended to be inclusive of all aspects of the subject matter disclosed herein, but rather to illustrate representative compounds, compositions, methods and results. These examples are not intended to exclude equivalents and variations of the present invention which are apparent to one skilled in the art.

### Example 1. Coupled Electrodialysis (ED) and Reverse Osmosis (RO)/Nanofiltration (NF) Treatment

Natural Organic Matter (NOM) refers to the organic material present in surface or ground water. NOM causes color and taste problems and reacts with Cl₂ to form disinfection byproducts such as THMs and haloacetic Acids (HAAs) that can increase the risk of cancer. Because regulatory limits not only focus on select DBPs (e.g., THMs and a subset of five HAAs) but also require reduction of NOM in treatment plants with a surface water source and groundwater under the influence of surface water, it is often advantageous to focus on removal of DBP precursors prior to disinfection to minimize health risks. Indeed, removal of NOM prior to disinfection can indirectly reduce health risks associated with both regulated and other DBPs.

Coagulation/flocculation and membrane processes—such as Ultra Filtration (UF), Nano Filtration (NF), and reverse osmosis (RO)—are possible methods to remove NOM. Among the available treatment methods, RO is superior in terms of NOM rejection in the feed water. RO has been shown to be effective in removing NOM from fresh water (Shen, J., & Schäfer, A. I. (2015). Science of the Total Environment, 527-528, 520-529). However, the presence of Ca²⁺ increases fouling due to the bridging of organic molecules (Lee, S., and Elimelech, M., (2006). Environmental Science & Technology, 40, 980-987). High concentrations of Ca²⁺ also leads to precipitate formation, usually calcium carbonate (CaCO₃). Therefore, temporary removal of ions prior to RO can provide a cost-effective technology for select systems. Ions—such as Ca²⁺—in NOM-containing natural water can be removed by electrodialysis (ED) (Zhang, Y., et. al. (2011). Journal of Membrane Science, 378(1-2), 101-110).

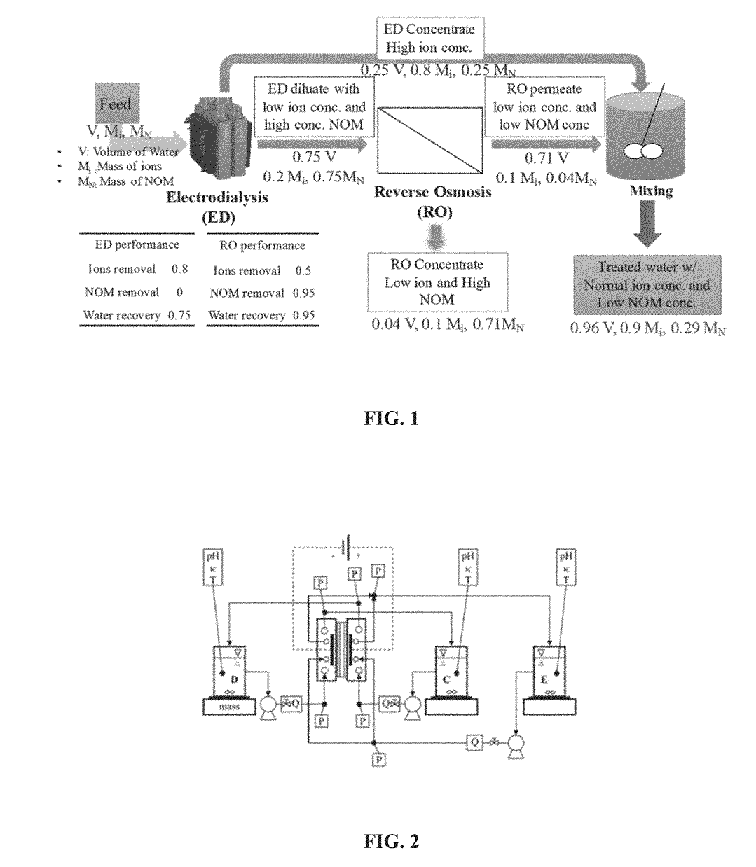

The application of a coupled ED-RO system (FIG. 1) has been shown to be effective for the NOM isolation in freshwater and seawater (Gurtler, B. K., et. al. (2008). Journal of Membrane Science, 323(2), 328-336; Koprivnjak, J. F., et. al. (2006). Water Research, 40(18), 3385-3392; Vetter, T. A., et. al. (2007). Separation and Purification Technology, 56(3), 383-387), but not in a process designed to specifically remove the NOM and leave the ions behind to obtain potable water. The water treatment process in this example employs ED to temporarily remove ions, and RO to separate NOM. The ED unit will remove most ions while achieving minimal removal of NOM, because diffusivity of NOM molecules is much less than that of common inorganic ions. The diluate (“the first diluate stream”) from the ED system will then be treated with RO, with the result that the concentrate from the RO process (“the second concentrate stream”) should contain most of the original NOM. Finally, the concentrate from the ED system (“the first concentrate stream”) will be recombined with the permeate from the RO (referred to as the “the second diluate stream”), resulting in water with nearly the same salt concentration as the original water but with greatly reduced NOM concentration. The calculation of water volume, mass of ions, and mass of NOM in each stage is included in FIG. 1. This same methodology using an RO membrane described herein, can also be used with replacement of the RO membrane with a nanofiltration (NF) membrane (or ultrafiltration membrane).

The complete ED unit or system consists of an electrodialyzer stack, data acquisition equipment, power supply system, pumps, and a computer for monitoring and control. FIG. 2 has a schematic of the laboratory-scale ED experimental apparatus. The unit is set up as a batch-recycle reactor; in this setup, the same water is put into both the concentrate reservoir (C in the diagram) and the diluate reservoir (D). During an experiment, the ion concentration in the diluate is reduced and that in the concentrate is increased. The apparatus is assembled with equipment for monitoring hydraulic, electrical, and chemical behavior including pressure transducers, pH/conductivity meters, thermometers, balances, and flow meters. Laboratory-scale gear pumps circulate diluate, concentrate, and electrode rinse. The pressure and the electrode rinse flow are monitored by National Instruments multi-function ADC (NI USB-6008); the concentrate and dilate liquid flow are monitored and controlled by National Instruments multi-function ADC (NI USB-6009); and mass, voltage, electrical current, conductivity, pH, and temperature measurements are transmitted through RS-232 serial connections. LabVIEW™ supervisory control and data acquisition (SCADA) software programs were developed to control and monitor the electrodialysis experiment continuously.

The electrodialyzer is an important part of the experimental setup. The experimental electrodialyzer is a PCCell ED Model 64002 (PCCell/PCA, GmbH, Germany). Both the anode and the cathode are expanded stainless steel. The end-plates surrounding the electrodes and compressing the stack are machined polypropylene. The manufacturer recommends a maximum voltage application of 2V per cell-pair and a maximum flow rate of 8 L/h per cell. The active cross-sectional area subjected to the applied electric field is 64 cm². The thickness of plastic-woven screen/mesh spacers is 0.41 mm, and the superficial (empty) volume is 2.6 cm³ per cell with an actual volume-porosity of 0.78. The flow path length is approximately 9.0 cm. A BK Precision® 9123A power supply controls and monitors the electrical voltage and current applied to the electrodialyzer.

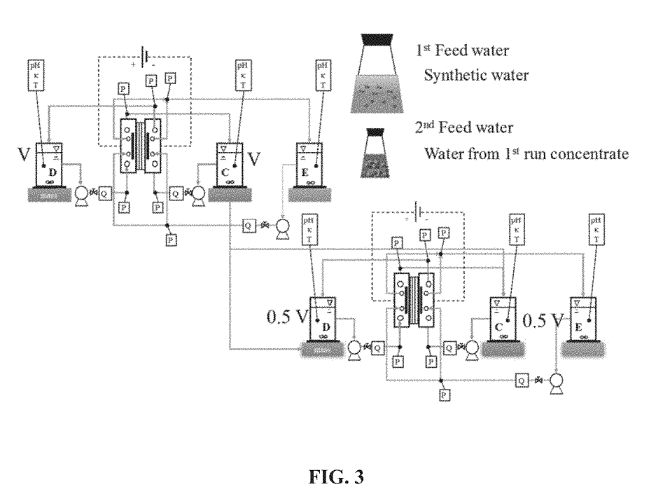

To improve water recovery, the ED system was operated twice in series. A schematic diagram of the series electrodialysis operation is in FIG. 3. In the second ED treatment, feed water (initial water in both reservoirs) is the concentrate from the previous experiment, and the amount of feed water is half of that of the first experiment. Since the second experiment starts with the concentrate of the first run, the target conductivity removal ratio should be greater than in the first experiment to achieve a similar conductivity of the first run in the diluate.

Table 1 shows the experimental conditions of series ED experiments that have been performed for series ED experiments and Table 2 shows the experimental conditions of single ED experiments that have CMV/AMV and PCSK/PCSA membranes for the series ED experiments and CMX/AMX and PCSK/PCSA membranes for single ED experiments. An anion selective membrane (Selemion AMV) and a cation selective membrane (Selemion CMV) were used in the investigation. AMV and CMV membranes are based on a styrene divinyl benzene co-polymer and are manufactured by Asahi Glass, Japan. The CMV membrane contains —SO₃Na functional groups, while the AMV membrane contains —NR₄Cl functional groups. PCSA and PCSK are homogeneous membranes. Both membranes are based on a polyester fabric and are manufactured by PCA-Polymerchemie Altmeier GmbH (Germany). The PCSK membrane contains —SO₃Na functional groups and the PCSA membrane contains —NR₄Cl functional groups. Neosepta CMX and AMX membranes are manufactured by Astom Corp., Tokyo, Japan. Neosepta. CMX and AMX membranes are heterogeneous membranes. CMX/AMX membranes are composed of poly(styrene-co-divinylbenzene) as a base material and poly vinyl chloride as a supporting material. The CMX membrane contains —HSO₃⁻ as functional groups. The AMX membrane contains —N(CH₃)₃⁺ as functional groups.

TABLE 1
Series Electrodialysis (ED) experimental conditions

| Variable | Standard value | Note |
|---|---|---|
| Membrane type | CMV/AMV, PCSK/PCSA | 9 cell pairs |
| Stack voltage | 1 V/CP | 9 V/Stack |
| Superficial velocity | 3.4 cm/s | |
| Feed water | Synthetic water | w/ NOM and |
| | | w/o NOM |
| Removal ratio | 1ₛₜ ED: 80%, 2_{nd} ED: 90% | |

TABLE 2
Single Electrodialysis (ED) experimental conditions

| Variable | Standard value | Note |
|---|---|---|
| Membrane type | CMX/AMX, PCSK/PCSA | 9 cell pairs |
| Stack voltage | 1 V/CP | 9 V/Stack |
| Superficial velocity | 3.4 cm/s | |
| Feed water | Synthetic water | Suwannee river NOM |
| | | Leonardite Humic |
| | | Acid |
| Removal ratio | 80% | |

For the series ED experiments, the synthetic water consists of 500 mg/L sodium chloride solution, 0.1 M phosphate buffer, 0.1 M sodium hydroxide solution for pH adjustment, and concentrated Lake Austin water for the water with NOM. Concentrated Lake Austin water has approximately 260 mg/L NOM as C; therefore, feed water is diluted 1:50 to achieve approximately 5 mg/L NOM (as C) concentration.

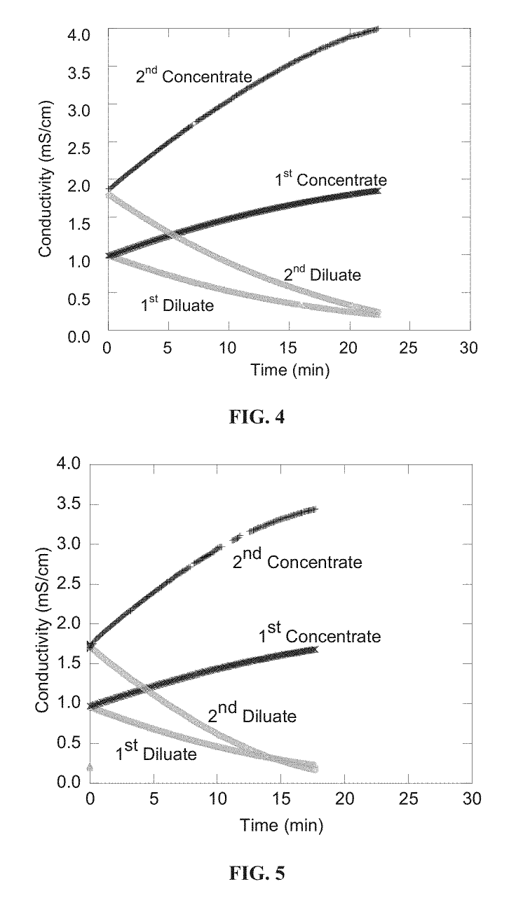

The experiments with 500 mg/L Total Dissolved Solid (TDS) without NOM were conducted as a control. FIG. 4 and FIG. 5 show how conductivities change through time. Conductivity, which is proportional to salt concentration, increases in concentrates and decreases in diluates. In both membrane pairs (CMV/AMV and PCSK/PCSA), the first ED run takes slightly longer to reach the target conductivity because the feed water amount is twice that of the second run.

The CMV/AMV membrane pair showed a slightly faster separation rate than the PCSK/PCSA pair. This difference reflects the difference of the Ion Exchange Capacity (IEC) of each membrane. The IEC of CMV is 1.95 meq/g, AMV is 1.98 meq/g, PCSK is 1.0 meq/g, and PCSA is 1.5 meq/g (Walker et al., 2014). The higher IEC indicates that the membrane can transport more ions in the water.

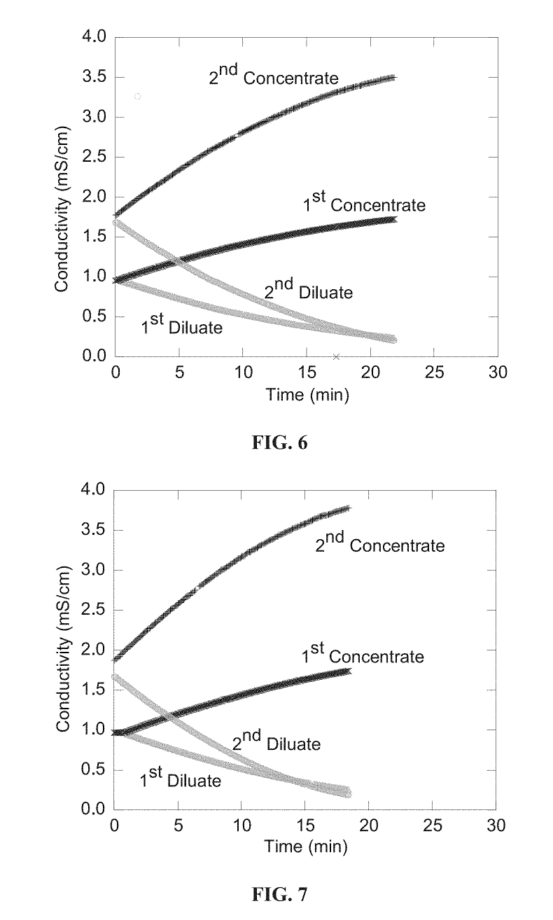

FIG. 6 and FIG. 7 show conductivity change through time in both membrane pair setups in the experiments with NOM present. The removal trend is similar to that of the control experiment in both setups. The salt removal rate of the CMV/AMV membrane pair is slightly higher than that of the PCSK/PCSA membrane pair.

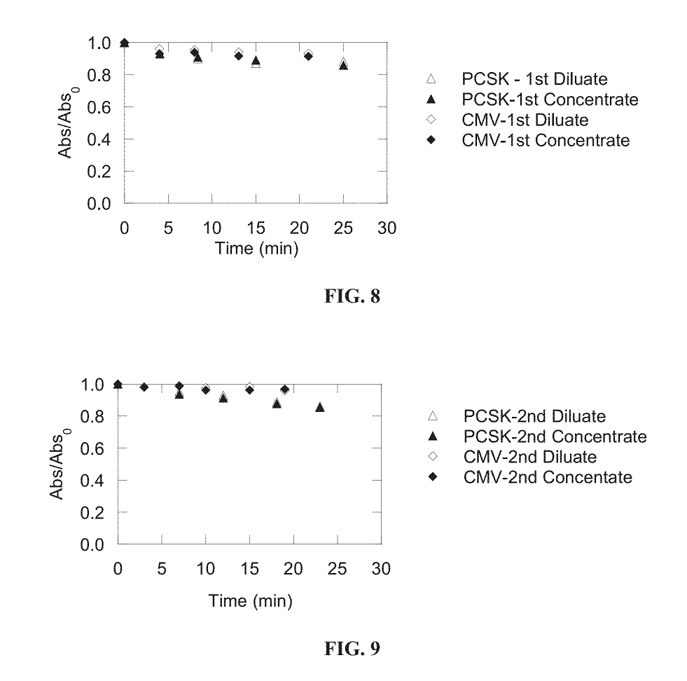

FIG. 8 and FIG. 9 show NOM UV absorbance (254 nm) change through time of the diluate in both membranes and both the first and second runs. The CMV/AMV membrane pair shows very little absorbance change with time, meaning that very little NOM passed through the membrane to the concentrate. The PCSK/PCSA membrane pair does show some decrease in absorbance with time, but the passage of NOM through the membrane was far less than that of the inorganic salt shown in FIG. 8 and FIG. 9. Although results for the two types of membranes differ somewhat, all four sets of data show a small decrease in the NOM concentration through the run, two possible reasons for these NOM concentration changes are NOM separation in ED or NOM accumulation on the membrane surface. The fact that the initial value in the second run (which reflects the ending value in the concentrate of the first run) is not higher than the initial value in the first run suggests that NOM accumulated on the membrane surface.

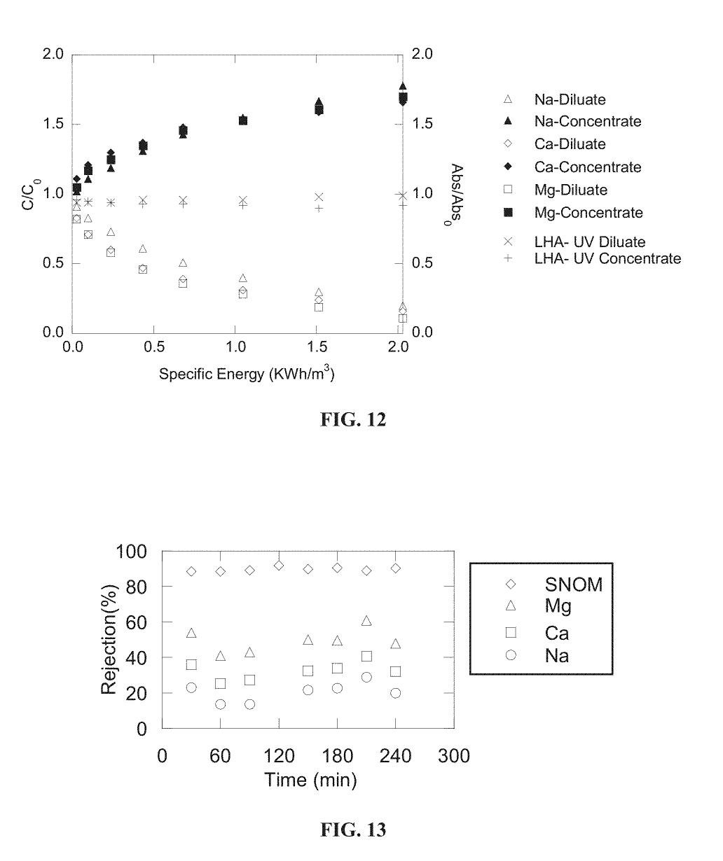

The possibility of NOM accumulation on the membrane surface is confirmed with TOC results of NOM concentration (Table 3). By calculating mass balance, the CMV/AMV membrane pair loses 1.15 mg of NOM during the first ED treatment and 1.82 mg NOM in the second ED treatment. The PCSK/PCSA membrane pair accumulates more NOM mass on the membrane surface compared to the CMV/AMV membrane pair, as expected from the results shown in FIG. 2. Generally, NOM is negatively charged in water at near neutral pH; therefore, NOM accumulates on the anion exchange membrane (AEM) surface. NOM concentrations of first series concentrate in both membrane pairs are similar to that of the feed water, indicating that ED does not separate much NOM. The accumulated NOM on the membrane can be removed during an acid wash process, or a combination of an acid wash and a base wash during general ED operation. Data from these laboratory studies indicate that complete recovery of the NOM is possible with these washes, confirming that adsorption to the ED membrane is the cause of the absorbance reduction seen in FIGS. 8-12.

TABLE 3
The total mass ratio (DOC/DOC₀) of NOM in a series ED system

NOM (DOC/DOC₀)

| Item | CMV/AMV | PCSK/PCSA |
|---|---|---|
| Feed | 1.00 | 1.00 |
| Diluate 1 | 0.82 | 0.85 |
| Feed 2 (Concentrate 1) | 1.00 | 1.00 |
| Diluate 2 | 0.85 | 0.86 |
| Concentrate 2 | 1.02 | 1.02 |

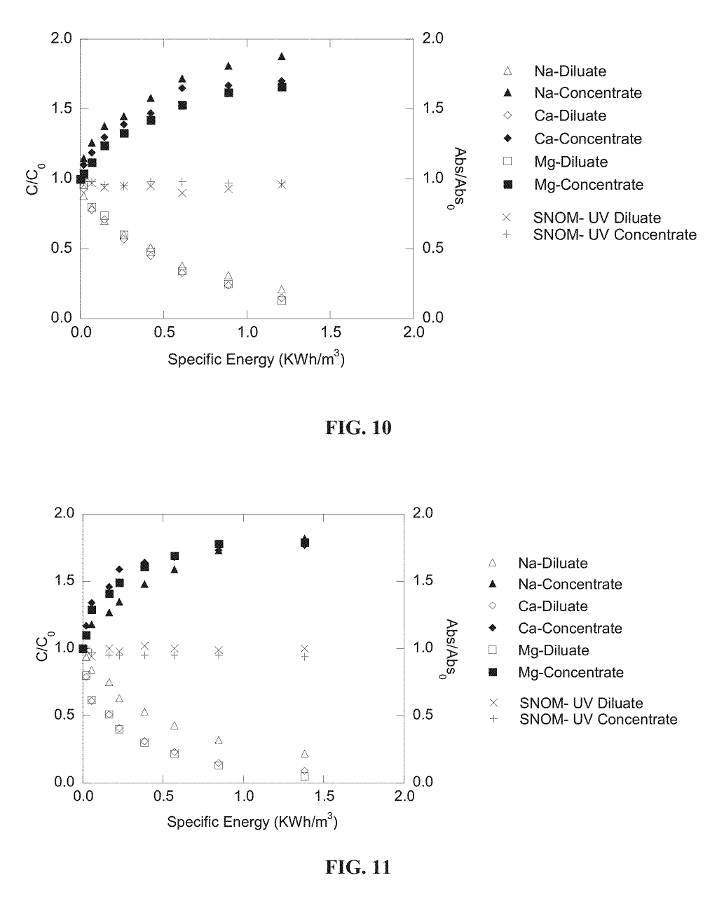

According to single ED experiments results, both the CMX/AMX and the PCSK/PCSA membrane pairs show similar ions separation trends (FIG. 10 and FIG. 11). But the CMX/AMX membrane pair shows slightly better separation of Na⁺, Ca²⁺, and Mg²⁺. Moreover, Ca²⁺ and Mg²⁺ separation in the CMX/AMX membrane pair were higher than Na⁺. Therefore, the CMX/AMX membrane pair is more appropriate with regard to removing divalent ions such as Ca²⁺ and Mg²⁺ for the combined ED/RO system; these ions are typically responsible for fouling of RO systems. According to the separation results of NOM, NOM does not separate significantly compared to the ions. The material comprising the PCSK/PCSA membrane pair has greater affinity for SNOM and LHA than the material comprising the CMX/AMX membrane pair. Therefore, the NOM mass loss was higher in the PCSK/PCSA membrane pair. By comparing SNOM and LHA experiments, the type of NOM does not appear to affect the NOM separation trends across the CMX/AMX membranes.

TABLE 4
The total mass ratio (DOC/DOC₀) of NOM in a single ED system

| | | | LHA |
|---|---|---|---|
| | SNOM (DOC/DOC₀) | | (DOC/DOC₀) |
| | CMX/AMX | PCSK/PCSA | CMX/AMX |
| Initial | 1 | 1 | 1 |
| 40% conductivity removal | 0.98 | 0.98 | 0.98 |
| Final | 0.97 | 0.93 | 0.97 |

The presence of NOM does not dramatically affect the performance of electrodialysis with respect to separating inorganic ions. Different membranes show slightly different salt separation rates and NOM separation trends. Comparison of CMV/AMV and PCSK/PCSA membrane setups and CMX/AMX and PCSK/PCSA membrane setups shows that the former combination is more appropriate for achieving low NOM separation and low NOM accumulation on the membrane surface in a coupled ED-RO system.

The ability of NF membranes to nearly completely remove NOM but remove lesser amounts of inorganic ions is illustrated in FIG. 13. These ion results were obtained from an experiment with a total TDS of 500 mg/L which would be on the upper end of those expected in the proposed process. The Suwannee River NOM concentration was 5 mg/L as carbon. The flow rate in the laboratory scale pressure membrane system with a flat sheet membrane with an active area of 42 cm² was 800 mL/min. Experiments with higher flow rate exhibited slightly higher rejection of each of the ions and the NOM.

The systems and methods of the appended claims are not limited in scope by the specific systems and methods described herein, which are intended as illustrations of a few aspects of the claims. Any systems and methods that are functionally equivalent are intended to fall within the scope of the claims. Various modifications of the systems and methods in addition to those shown and described herein are intended to fall within the scope of the appended claims. Further, while only certain representative system and method steps disclosed herein are specifically described, other combinations of the systems and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

We claim:

1. A system for processing a water sample, comprising:
a) an electrodialysis unit; and
b) a pressure membrane unit;
wherein the pressure membrane unit is present in the system after the electrodialysis unit, and
wherein the system removes organic matter present in the water sample, and the system retains a significant percentage of cations and anions in the water sample.

2. The system of claim 1, wherein the organic matter comprises natural organic matter.

3. The system of claim 1, wherein the water sample comprises a surface water source.

4. The system of claim 1, wherein the water sample comprises wastewater.

5. The system of claim 1, wherein the pressure membrane unit comprises a membrane suitable for nanofiltration.

6. The system of claim 1, wherein the pressure membrane unit comprises a membrane suitable for reverse osmosis.

7. The system of claim 1, wherein the electrodialysis unit comprises a cation selective membrane and an anion selective membrane.

8. The system of claim 1, wherein the electrodialysis unit comprises an electrodialysis stack, wherein the electrodialysis stack is comprised of at least two alternating cation selective membranes and anion selective membranes in series.

9. The system of claim 1, wherein the system contains at least two electrodialysis units.

10. The system of claim 1, wherein the system contains at least two pressure membrane units.

11. The system of claim 1, wherein a diluate stream from the electrodialysis unit which is further processed by the pressure membrane unit.

12. The system of claim 1, wherein the diluate stream from the electrodialysis unit that is processed by the pressure membrane unit, is combined with the concentrate from the electrodialysis unit.

13. A method for the removal of organic matter from a water sample, comprising:
a) providing a water sample;
b) separating the water sample by electrodialysis into a first concentrate stream and a first diluate stream, wherein the first concentrate stream comprises a higher fraction of ions than the water sample and the first diluate stream comprises a lower fraction of ions than the water sample;
c) processing the first diluate stream in a pressure membrane process into a second concentrate stream and a second diluate stream, wherein the second concentrate stream comprises a higher fraction of organic matter than the water sample and the second diluate stream comprises a lower fraction of organic matter than the water sample; and
d) combining the second diluate stream with the first concentrate stream.

14. The method of claim 13, wherein the organic matter comprises natural organic matter.

15. The method of claim 13, wherein the water sample comprises a surface water source.

16. The method of claim 13, wherein the water sample comprises wastewater.

17. The method of claim 13, wherein the pressure membrane process is nanofiltration.

18. The method of claim 13, wherein the pressure membrane process is reverse osmosis.

19. The method of claim 13, wherein the first diluate stream is further separated by an additional round of electrodialysis before processing in a pressure membrane process.

20. The method of claim 13, wherein the electrodialysis comprises a cation selective membrane and an anion selective membrane.
